(19) United States
(12) Patent Application Publication
(10) Pub. No.: US 2014/0100924 A1
(43) Pub. Date: Apr. 10, 2014

(54) INTEGRATED SYSTEM AND METHOD FOR SOCIAL OPINION NETWORKING

(71) Applicants: Robert Ingenito, New York, NY (US); Joseph M. Cali, Ridgefield, CT (US)

(72) Inventors: Robert Ingenito, New York, NY (US); Joseph M. Cali, Ridgefield, CT (US)

(21) Appl. No.: 14/051,002

(22) Filed: Oct. 10, 2013

Related U.S. Application Data
(60) Provisional application No. 61/711,990, filed on Oct. 10, 2012.

(51) Int. Cl. G06Q 50/00; G07C 13/00

(52) U.S. Cl. CPC G06Q 50/01; G07C 13/00
USPC 705/12

(57) ABSTRACT

A computer solution inclusive of web-enabled client-server hardware architecture and a unique software method for soliciting, sharing and influencing opinions on social issues. The software gathers metrics from collective opinions and facilitates social-networking using these metrics to guide members in forming informed opinions. Specifically, users are given feedback on their personal opinion selections, others' opinion selections, % in agreement, and other statistics or demographics. Each user is given the ability to “Change Opinion” base on this feedback.

### CROSS-REFERENCE TO RELATED APPLICATION(S)

The present application derives priority from U.S. Provisional application Ser. No. 61/711,990 filed Oct. 10, 2013.

### BACKGROUND OF THE INVENTION

1. Field of the Invention

The present invention relates generally to social computer networking and, more particularly, to a networking system that facilitates expressing, sharing, and changing opinions on social issues.

2. Description of the Background

Everyone has opinions, and the strongest opinions typically relate to social issues such as politics, entertainment, health, etc. These opinions can be formed from research and introspection, or through interactions with others. There has recently been an increased TV and radio effort to make people aware of social issues, but only due to the popularity of “attack” journalism, which is subject to the bias of journalists and news producers within the mass media in the selection of events and stories that are reported and how they are covered.

We are heavily dependent on others to shape our views of the world, and opinion formation depends on the interactions that take place with others. The internet has started to change these interactions, making it easier to propagate points of view and misleading facts through vast numbers of people. Such views and opinions are accepted and communicated on to others without much critical examination.

Opinion formation depends heavily on the structure of the social network in which individuals are embedded. What is needed is a social networking speed bump that provides incentive for people to thoughtfully form their own opinion based on myriad opinions from others, and to continually evolve their opinions based on social discourse.

There have been prior art efforts to provide opinion sharing platforms.

For example, U.S. Pat. No. 8,135,693 to Brazier et al. issued Mar. 13, 2012 shows a method for compiling, trend-tracking, transmitting and reporting opinion data. The opinions of various users are stored in a user opinion database, and the compilation of these user opinions are stored for real-time, pulse-polling, trend-tracking opinions. However, the architecture is designed to streamline the process of communicating user opinions to elected officials.

United States Patent Application 20080103877 by David Gerken published May 1, 2008 shows a method for soliciting, tracking, aggregating and reporting popular and group-specific opinion data via the Internet. Polls and poll results are posted by users to third-party Web sites, personal Web pages and emails, and as remote users' vote the central results are updated on a poll aggregation Web site and republished.

United States Patent Application 20050273804 to Preisman (Showtime Networks) published Dec. 8, 2005 is also a computer system for compiling an aggregated polling result, and displaying an animated, continually-updated depiction of the aggregated polling result.

U.S. Pat. No. 6,457,045 to Hanson et al. (Zaplet, Inc.) issued Sep. 24, 2002 is an early email-response aggregation patent. A participant creates an electronic form specifying the subject matter of a choice topic and a list of emails for other participants. A server receives the form and delivers an electronic mail message with static and dynamic regions.

United States Patent Application 20120011006 by Schultz et al. published Jan. 12, 2012 shows a system and method for real-time analysis of opinion data in which user opinion data is aggregated with other users' opinion data and provided as a graph along a timeline in real-time.

U.S. Pat. No. 7,319,863 to Engstrom et al. (Wildseed, LLC) issued Jan. 15, 2008 shows a method and system for providing an opinion and aggregating opinions with mobile telecommunication device. Users are solicited for their opinion. The opinion is aggregated with other opinions received from other mobile devices and the result is provided to the user along with a visual representation of the number of users who have provided positive and negative opinions, the levels of the user's opinions. By virtue of this opinion sharing, users may decide to change their opinion.

U.S. Pat. No. 6,418,308 to Heinonen et al. (Nokia) issued Jul. 9, 2002 shows an opinion poll utilizing a wireless data transmission connection that imposes a predetermined answering period Query messages are broadcast to recipient mobile stations and their users are allowed, at a convenient moment, to enter a written answer message to the mobile station. The written answer messages are sent wirelessly to the service center, forwarded from the service center to the data processing block; and processed by the data processing block, if received by the processing block within the answering period.

The SodaHead website at http://www.sodahead.com/ provides an outlet for people to ask questions, post breaking news of the day, and share his/her opinions on issues. Members may pose a question to the community; answer other people's questions, vote on, comment on, and debate on various topics. SodaHead leverages its technology through a polling web widget where users can add videos and images, promote the poll in hopes it will go viral and customize the look and feel. Users post their categorical opinions on issues and these are posted along with forum discussions. Users typically lobby in their forum posts to change other people's opinions, and users are always free to do so. A typical issue is: Sofia Vergara: Who's the Sexiest TV Actress? Vote yes or no. Cumulative voting is displayed and users can change opinions.

The foregoing references allow expression of opinions, and changing of opinions based on other opinions. However, their social networking frameworks do not allow users to compare their opinions in a meaningful multi-faceted manner. They assume that opinion formation comprises a sequence of synchronous decisions by individuals based on the collective opinions of a generic crowd. This is not true. Opinion formation is asynchronous and opinions may change over time. Moreover, the social status of others bears heavily on opinion formation, e.g., friends and frame often have a greater influence on opinions. Different people attach different weights to the opinions of others, depending on their social status. Where one individual may attach greater influence to a friend's opinion, another may attach more influence to a news commentator. Therefore, any truly opinion-nurturing system should allow a user to compare their opinion to a customizable peer group, and view metrics and analysis that provide an intelligent demographic comparison of opinions. The foregoing is herein made possible in the context of a social networking framework that gives participants the opportunity to share their opinions on a variety of topics, compare them to other members, communicate, and change their opinions. Robust comparisons can be made by demographic such as age, gender or religion or by managed groups of friends, business associates, family members, associations, etc. This allows participants to easily gauge where their opinion fits in amongst other participants.

### SUMMARY OF THE INVENTION

It is, therefore, an object of the present invention to provide an integrated system and method for expressing, sharing, and networking in regard to opinions on social issues in order to facilitate more informed opinion formation and adaption.

According to the present invention, the above-described and other objects are accomplished, by a computer solution inclusive of a web-enabled client-server hardware architecture and a unique software engine and method that provide a platform for soliciting, sharing and influencing opinions on social issues. The invention gathers metrics from collective opinions and facilitates social-networking using these metrics to guide members in forming informed opinions. Specifically, users are given feedback on their personal opinion selections, others' opinion selections, % in agreement, and other statistics or demographics. Each user is given the ability to “Change Opinion” base on this feedback. Higher level administrative metrics are also maintained to help foster opinions.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is system architecture diagram.

FIG. 2 is logical flow chart of the social opinion expression, sharing, and change process according to the invention.

FIG. 3 is a screen print of the user login/registration landing page.

FIG. 4 is a screen print of an exemplary View Content screen.

FIG. 5 is a screen print of an exemplary Issues Page

FIG. 6 is a screen print of an exemplary Topic

FIG. 7 is a screen print of the post-vote voting controls

FIG. 8 is a screen print of the email/invitation sent to the designated friend

FIG. 9 is a screen print of the Voting Wall 70

FIG. 10 is a screen print of the Member Management interface.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is a computer-based interactive social-networking system that includes a web-enabled client-server hardware architecture and a unique software method that combine to provide a platform for soliciting, sharing and influencing opinions on social issues. The invention solicits subscriber opinions, gathers metrics from collective opinions, and facilitates social-networking using these metrics to assist members in developing more informed opinions. Specifically, users are given customizable feedback on their personal opinion selections, relative to others' opinion selections, including % in agreement and other statistics or demographics. The feedback is presented in a “Voting Wall” which is customizable to allow for opinion comparison against a user-selectable baseline of other opinions. Each user has the freedom to define a peer group against which their opinions are compared, and may make multiple comparisons against multiple peer groups and take part in formative social networking to debate the social issues. Each user is given the ability to “Change Opinion” based on this feedback and collaboration. In addition, higher level administrative metrics are also maintained to help foster opinions and to monitor the opinion formation process.

The system for expressing, sharing, and changing opinions on social issues is herein implemented in the context of an application service provider (ASP) computer network to facilitate subscriber use of the present method in software form.

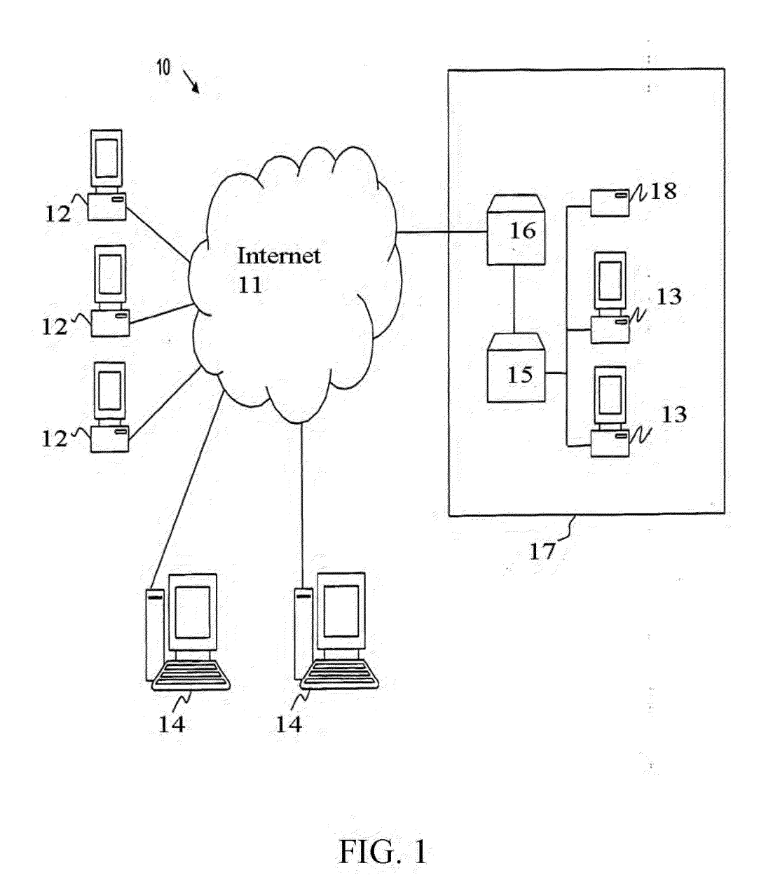

As shown in FIG. 1, ASP network 10 may include a plurality of clients 12 and servers 14 connected via the internet 11. Any number of clients 12 and servers 14 may participate in such a network 10. The system further includes at least one ASP local area network 17 (“LAN”) for hosting and allowing administration of the system by administrators using internal ASP client stations 13. The internet or World Wide Web provides a known system for interconnecting clients 12, servers 14 and ASP LAN 17 in a communicating relationship. However, other networks may be used, such as satellite networks, the Public Switched Telephone Network, WiFi networks, WiMax networks, cellular networks, and any other public, private, or dedicated networks that might be used to interconnect devices for transfer of data.

Subscribers will typically access the system via a client 12, which may be any suitable computing device including mobile devices such as laptops, monitors, POS, POI, PDAs, cell phones and the like, or stationery personal computers. Suitable computing devices have an input device, display, processor, memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, plus a communication port such as a digital subscriber line (“DSL”) card, cable modem, network interface card, wireless network card, or other interface device capable of wired, fiber optic, or wireless data communications. Client 12 must be equipped with an operating system such as Microsoft Windows®, UNIX, or Linux capable of hosting Internet communication protocols. The client 12 also includes at least one browser program, such as Microsoft Internet Explorer, Google Chrome™, Netscape Navigator™, FireFox™ or the like to provide a player interface for access to the software, or alternatively thin-client front end software downloaded from server 14 ASP LAN 17 and installed locally on client terminals such as cellular phones, tablets and personal digital assistants (PDAs), or other portable computing devices.

ASP LAN 17 comprises a plurality of ASP clients 13 clustered together through a hub 15 (for example, a peer network such as a wired or wireless Ethernet network) or a local area network server (in, for example, a client-server network).

Secure communication lines are used between clients 12, servers 13 and ASP LAN 17 so that private data remains so. Moreover, the ASP LAN 17 is preferably connected to the internet 11 through a secure gateway 16 which ensures security of subscriber data as well as operating compatibility between the ASP LAN 17 and the internet 11.

An exemplary ASP client 13 is a suitable computing device as defined above. The present invention is data intensive, and at least one ASP server 18 in ASP LAN 17 is a database server running database management software to provide database services to ASP LAN 17 and subscriber clients 12 and servers 14, as defined by the ASP client-server model. Database management systems frequently provide database server functionality, and some DBMSs (e.g., MySQL) rely exclusively on the client-server model for database access. Thus, ASP server 18 preferably hosts a network database, preferably an SQL server database, running MySQL (a popular open source database). Other examples of suitable database servers are Oracle™, DB2™, Informix™, Ingres™, and SQL Server™

The secure gateway 16 may be a Citrix Access Gateway®, or other suitable secure data access solution that provides administrators via ASP clients 13 with software and data-level control while providing subscribers with remote access via subscriber clients 12 for securing the delivery of data and populating data to clients 13 and servers 14 anywhere. Gateway 16 provides security to the ASP LAN 17 and ensures operating compatibility between the ASP LAN 17 and the internet 11.

The ASP server 18 hosts a web server which delivers a user interface (UI) having data-entry capability by transmitting web pages in hypertext markup language (HTML) or extensible markup language (XML) (or a similar scheme) using the hypertext transport protocol (http) to any of clients 12, 13 or servers 14.

The ASP server 18 also hosts an analytical comparison engine for calculating and displaying opinion comparisons based on user-selectable peer groupings. When subscriber initial data entry of opinions is complete, the analytical rules-based comparison engine subjects the subscriber results to a comparison based on the voting population, and the Voting Wall allows subscriber filtering of custom-defined peer groupings to be sent to the comparison engine, allowing robust user-defined comparisons and displays thereof that likewise appear on the Voting Wall.

The software method of the invention, delivered through the foregoing network, enables individuals to register as subscribers, and thereafter login, selectively view social topics and social issues, enter opinions on said issues, and selectively share, network, inform the opinions or peers, and/or be influenced and change their own opinions, all as described further herein. The method of accomplishing this will now be described in detail.

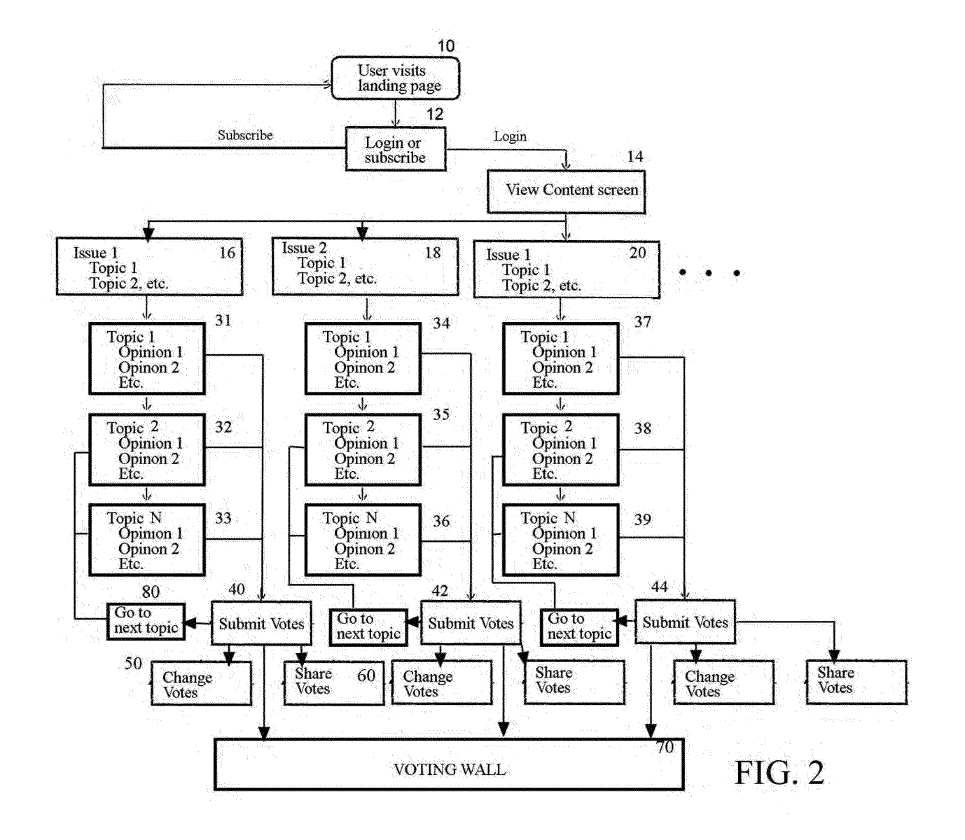

FIG. 2 is logical flow chart of the social opinion expression, sharing, and change process according to the invention.

At step 10, when users visit the site, they encounter a landing page with marketing content. The landing page invites subscribers to sign in, which will be applicable to subscribers who have already registered, or new users to register.

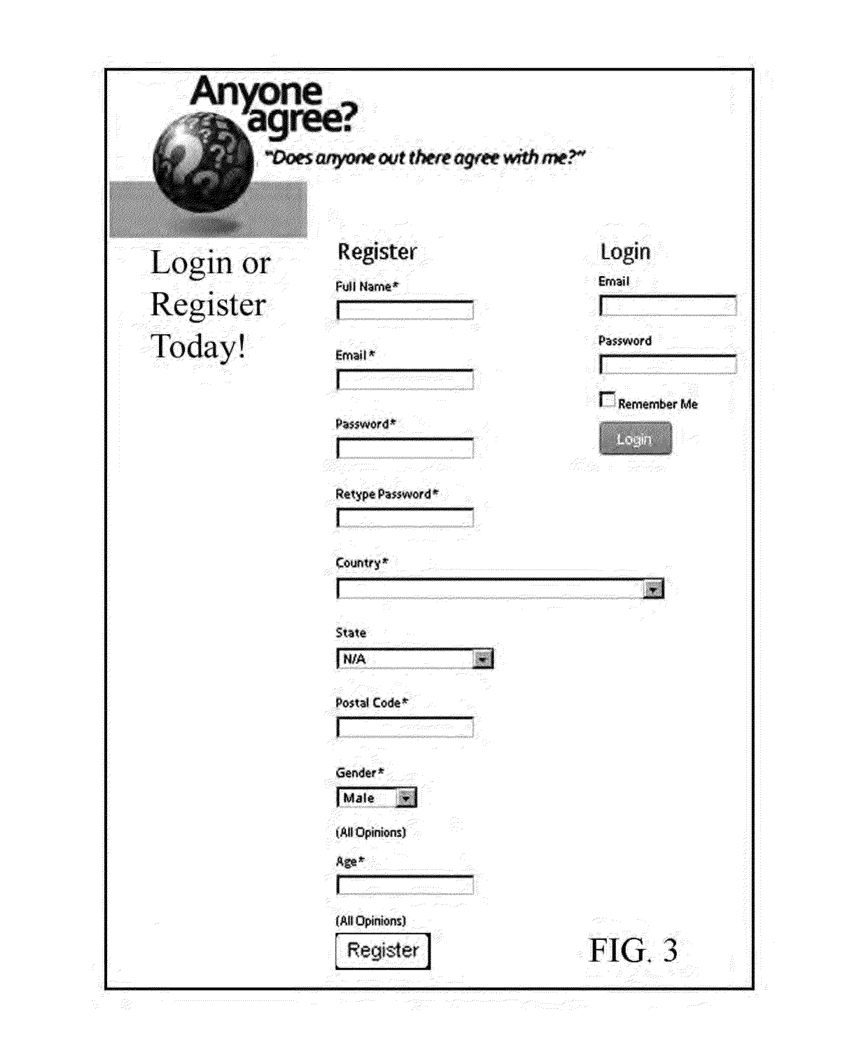

FIG. 3 is a screen print of the user login/registration landing page. When registering as a new subscriber (FIG. 2 step 12) a registration form is completed with minimal personal information and demographics (full name, email address, password, country, state, postal code, gender and age). Once properly registered, the subscriber need only log in as shown at right (FIG. 3).

Once logged in, at step 14 (FIG. 2) the subscriber is presented a View Content screen which presents a list of defined Issues, shown at steps 16-20 of FIG. 2.

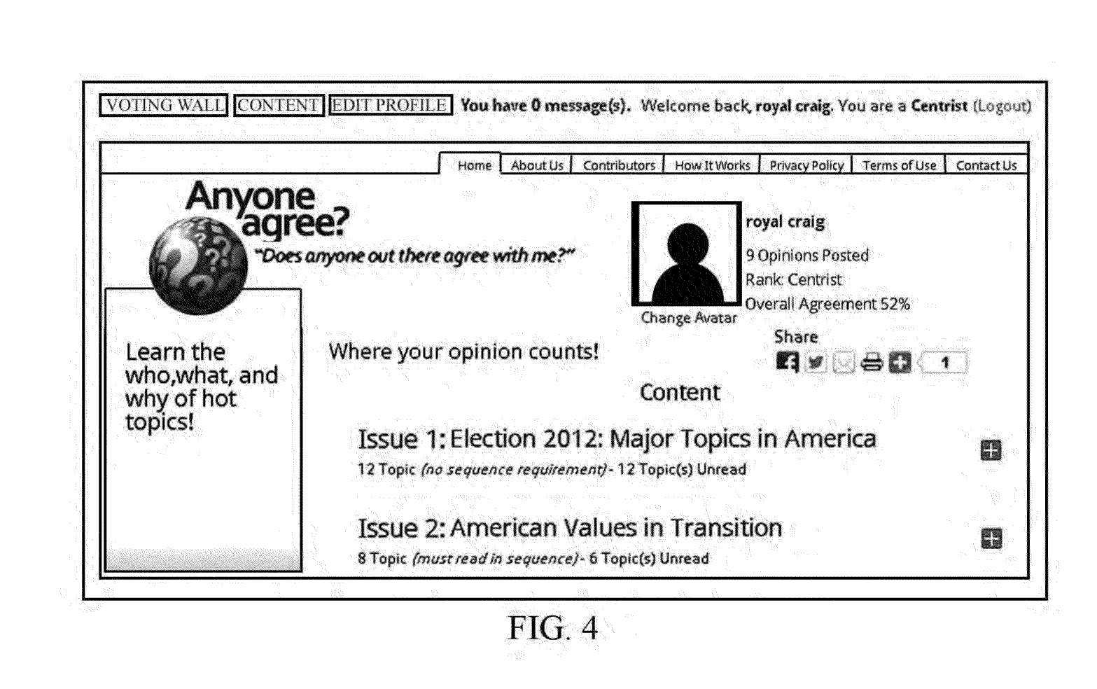

FIG. 4 is a screen print of an exemplary View Content screen. This View Content Screen presents a list of two defined Issues:

Issue 1: Election 2012: Major Topics in America (this issue contains 12 topics).

Issue 2: American Values in Transition (this issue contains 8 topics).

There may be as many Issues as desired. The subscriber may click on any Issue to be brought to the respective Issues Page to view the Issue and its Topics.

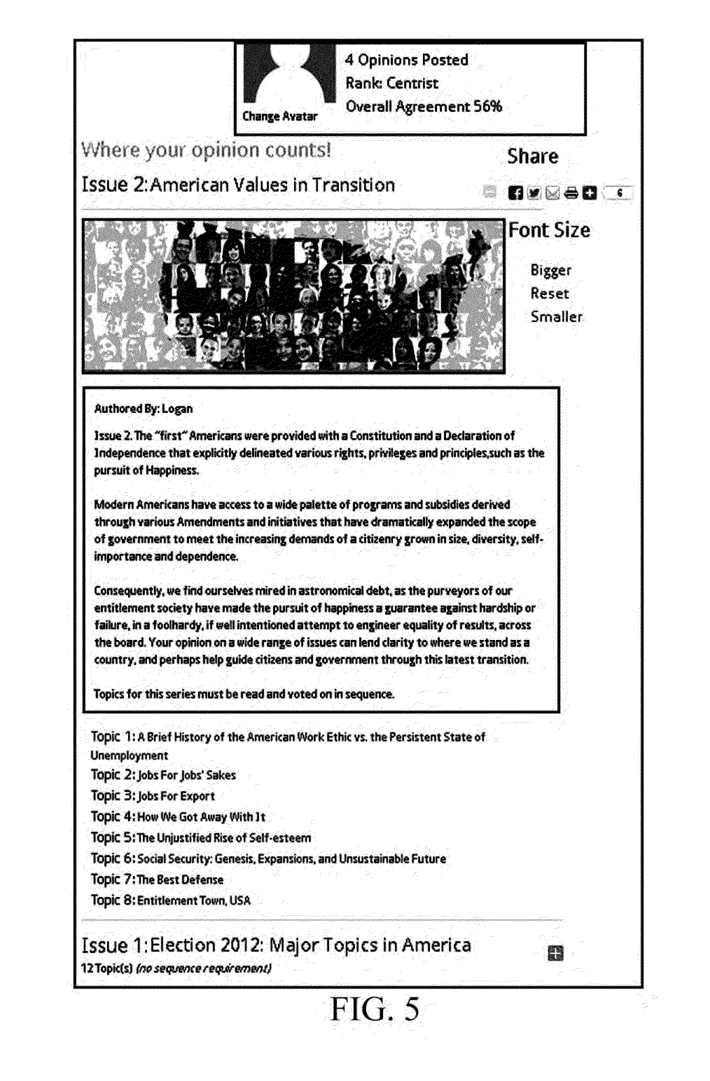

FIG. 5 is a screen print of an exemplary Issues Page depicting “Issue 2: American Values in Transition.” Issues are solicited from any outside party, screened, and selectively posted by the ASP. When posted, the author's brief biography is also posted and the subscriber may click on the issue author's name to view the brief biography. Issue 2 presents the social problem of growing entitlements versus growing debt, and asks where we stand as a country.

Each Issue can have one or more Topics, and each Topic can be voted on individually (see steps 31-39 of FIG. 2).

As seen in FIG. 5, exemplary Topics for this Issue must be read and voted on in sequence and include.

### Topic 1: A Brief History of the American Work Ethic vs. the Persistent State of Unemployment

### Topic 2: Jobs For Jobs' Sakes

### Topic 3: Jobs For Export

### Topic 4: How We Got Away With It

### Topic 5: The Unjustified Rise of Self-esteem

### Topic 6: Social Security: Genesis, Expansions, and Unsustainable Future

### Topic 7: The Best Defense

### Topic 8: Entitlement Town, USA

The subscriber may click on a Topic to expand the entire article. Thus, if they click on Topic 1: A Brief History of the American Work Ethic vs. the Persistent State of Unemployment, they are presented with a narrative framing the social issue underlying the Topic The American Work Ethic vs. The Persistent State of Unemployment.

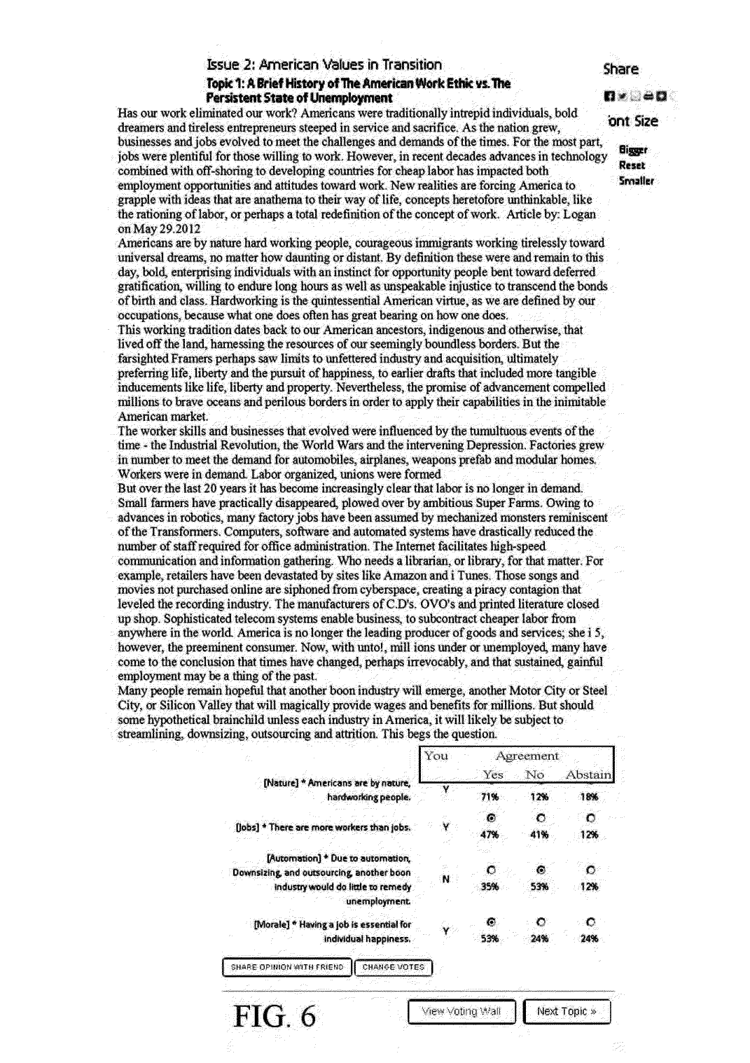

FIG. 6 is a screen print of an exemplary Topic 1: A Brief History of The American Work Ethic vs. The Persistent State of Unemployment. After reading the Topic, the subscriber may Vote on points of contention using the voting controls shown at bottom.

The voting controls list each Item of contention, categorically, and provide corresponding voting button selection from among “Yes”, “No”, and “Abstain.” In this instance the subscriber may vote on the following Items of Contention:

| | | | |
|---|---|---|---|
| [Nature] Americans are by nature, hardworking people. | Y | N | A |
| [Jobs] There are more workers than jobs. | Y | N | A |
| [Automation] Due to automation, Downsizing, and | Y | N | A |
| outsourcing, another boon industry would do little | | | |
| to remedy unemployment. | | | |
| [Morale] Having a job is essential for individual happiness. | Y | N | A |

Once selections are made the subscriber enters their votes by pressing the “VOTE” button at bottom. If the user selects Abstain, they have the ability to add a brief comment explaining why. Importantly, only the author of the Issue/Topic will see the abstain comment.

Once the votes are cast they are submitted to the software comparison engine (see also steps 40-42 of FIG. 2), comparative results are tabulated based on the entire (default) voting population, and the voting controls change to display the comparative results and provide more subscriber post-voting options.

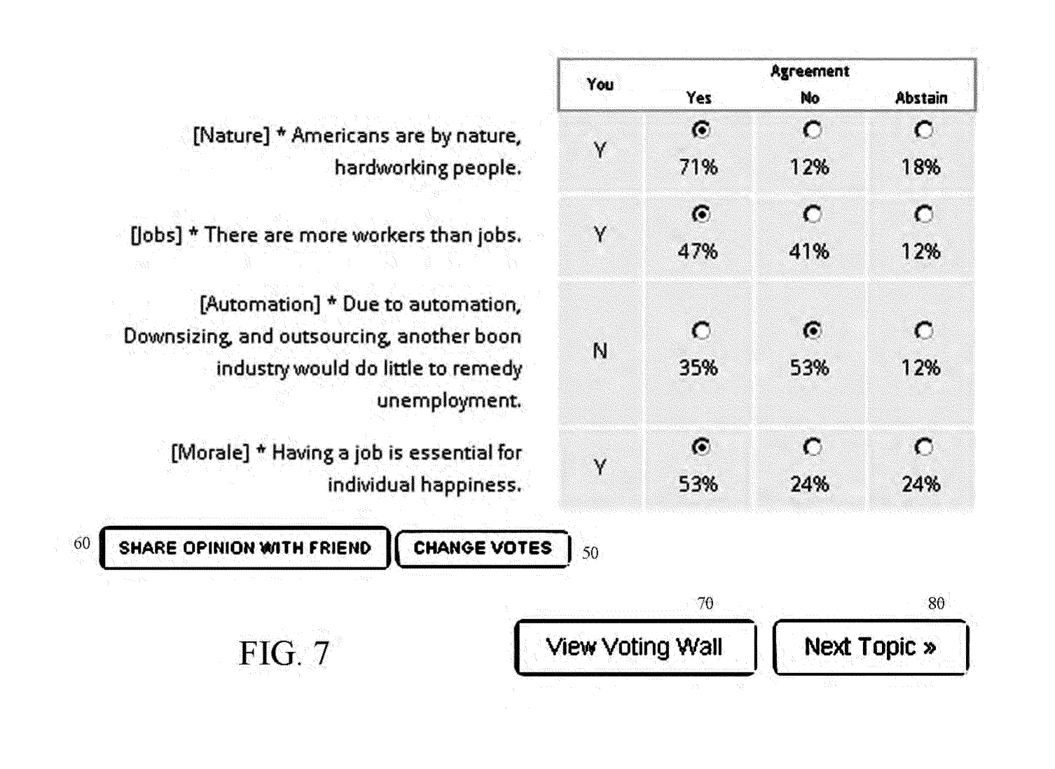

FIG. 7 is a screen print of the post-vote voting controls, and post-voting options include change your votes 50, share your opinion with a friend 60, view the Voting Wall 70, and go to the next Topic 80.

The comparative results categorically indicate the present subscriber's vote, and the percentage of the general voting population that voted yes, no or abstain. Note that each percentage display includes a voting button which allows the subscriber to change their vote if influenced.

The Share Opinion with Friend button 50 allows the subscriber to share their voting opinions via email. From the voting area on the Topic Page, they click Share Opinion with Friend a pop-up box appears soliciting entry of the friend's email address. Once entered, the ASP sends an email with a hyperlink to the designated friend, and the subscriber receives a confirmation message that their opinion was shared with the friend.

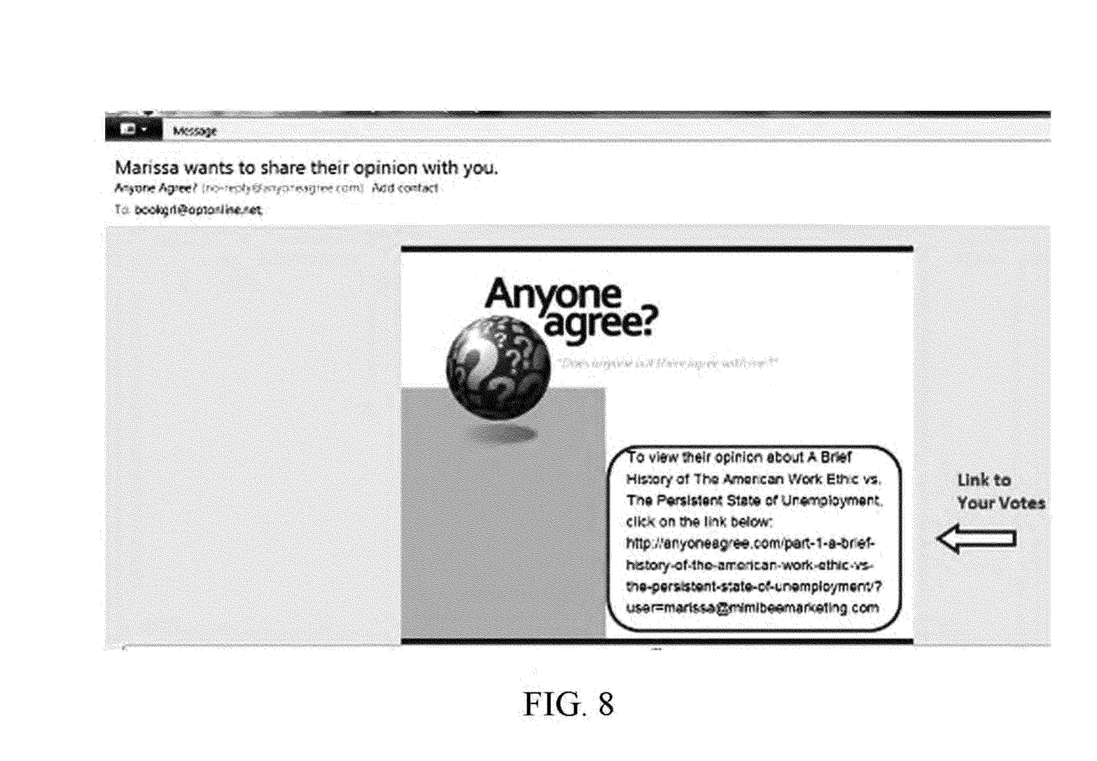

FIG. 8 is a screen print of the email/invitation sent to the designated friend. The hyperlink opens a results page.

Referring back to FIG. 6 a control box is shown at top right which allows the subscriber to share Topics with friends via email or social networking sites. To share a topic via email, from the Topic Page the subscriber clicks the email icon in box, type in their friend's email into the pop-up box which appears, and (optionally) enters a brief note. When they click Send the designated friend will receive an email with a link that will direct them to the topic.

The application is integrated with social media services including Facebook® and Twitter® so that players can share topics via these channels, similar to the email topic-sharing, but through access to their Twitter® or Facebook® accounts. The ASP software synchronizes to these social networking accounts so that the sharing invites are tweeted on Twitter® or posted to Facebook®.

Once votes are cast, as seen at the bottom of FIG. 7, the user may proceed to view the next Topic 80 or view the Voting Wall 70.

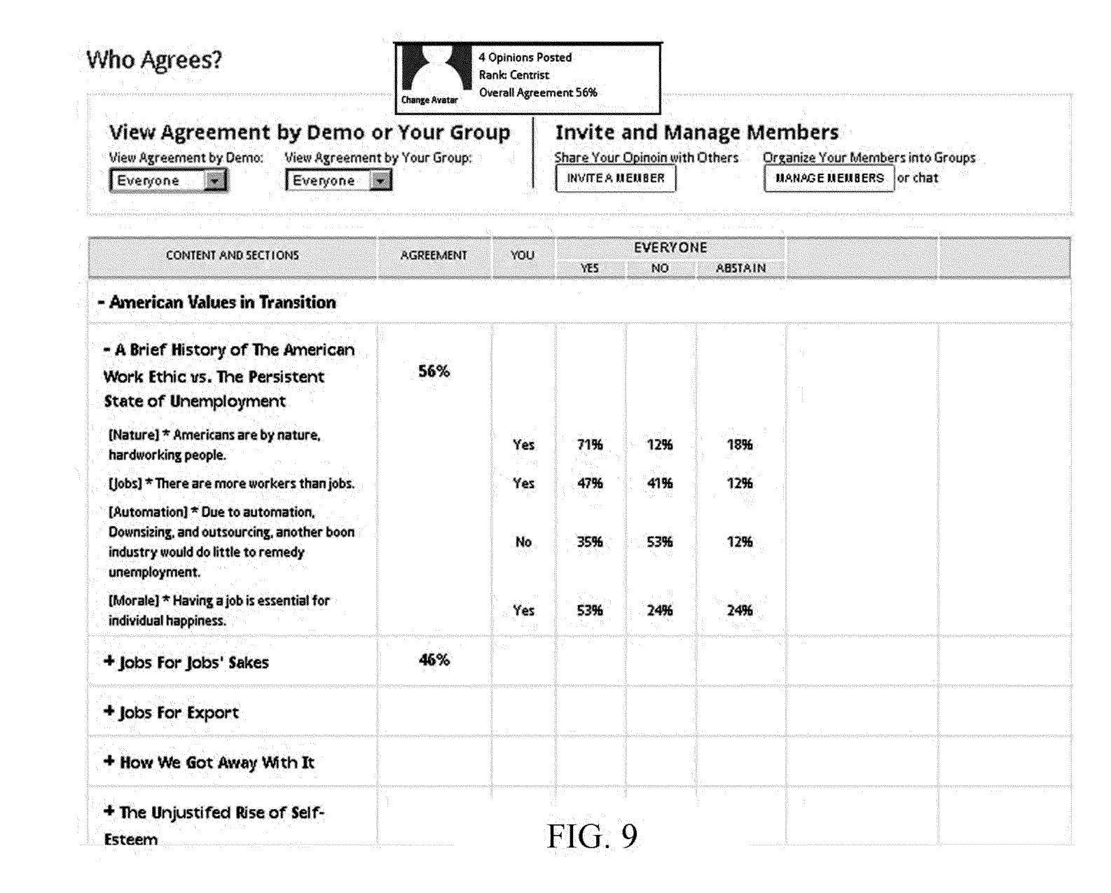

FIG. 9 is a screen print of the Voting Wall 70, which allows subscriber filtering of custom-defined peer groupings to be sent to the comparison engine, allowing robust user-defined comparisons and displays that illustrate how subscriber votes compare to everyone else that voted on the Topic. The left column displays a collapsible list of Issues, Topics, and Points of Contention. The subscriber can view the results of the issues they voted on by clicking on the + button to maximize the issue and view all topics within the issue, then click on the link to Topic to view voting for that topic. The filter controls at top left allow the subscriber to filter the displayed results by demographic, member group, or both. Both controls include a dropdown menu. The demographic dropdown menu gives the option to sort votes by Age, Gender, U.S. Region, Continent, Politics, and/or Religion. The Member Group dropdown menu gives the option to sort votes by subscriber-defined member groups. With filters selected the ASP server 18 analytical comparison engine recalculates the voting statistics accordingly and displays opinion comparisons based on the user-selected filters as shown at center.

The present application combines its opinion-influencing Voting Wall function with a social networking function. In that regard subscribers may create and manage member groups by saving “friends” into groups that they create, for example business, family, etc.

From the Voting Wall of FIG. 9, the subscriber may click “Manage Members”. This initiates the Member Management interface.

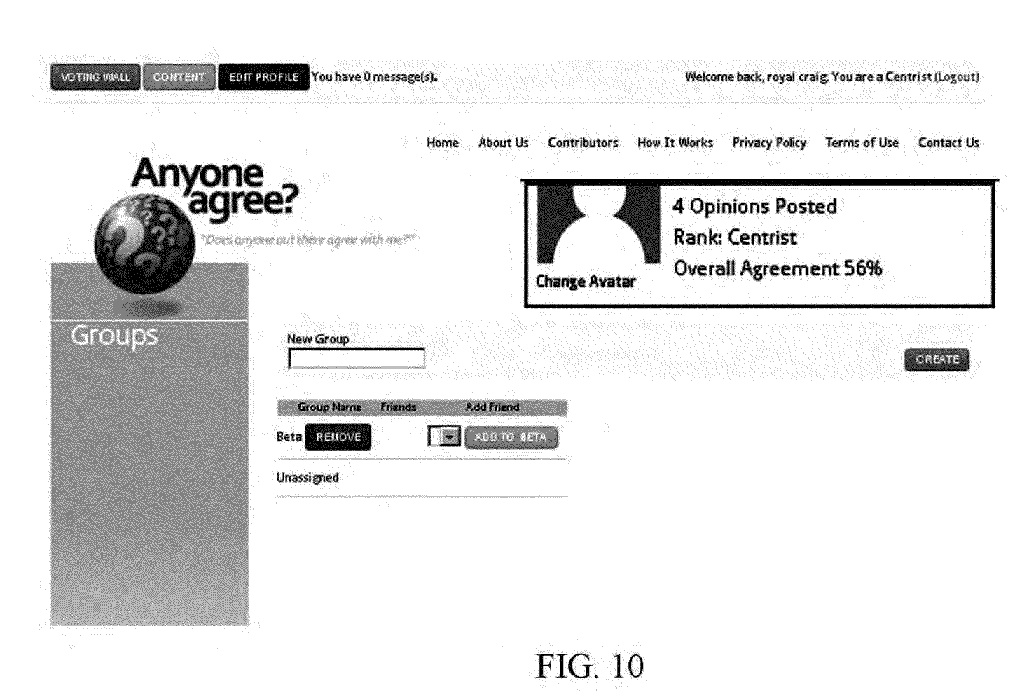

FIG. 10 is a screen print of the Member Management interface. The subscriber can create and name a new group, add their designated friends to the group using the controls at left center, or remove friends from groups. When filtered by Member group on the Voting Wall (FIG. 9) the subscriber will only see voting results for the selected Member Group. In addition, each group member's vote is displayed and by simply clicking on that vote the subscriber can start a conversation with their friend. They type in a brief message, which will be sent to them on their Message Page and via email.

The subscriber can invite a new non-subscriber or existing subscriber to become a subscribed friend by clicking the Invite a Member button (see FIG. 9, top right). A pop-up box appears soliciting entry of the friend's email address. Once entered, the ASP sends an email with a hyperlink invitation to the invitee inviting them to become a Member and/or friend, and if they are already subscribed it posts a message on the invitee's Message Wall. The invitee always has the option to Accept or Reject the request. The subscriber receives an email in return when the friend accepts the member request, and at this point the subscriber may go to their Voting Wall and add the new member into a Member Group.

It should now be apparent that the above-described integrated system and method provides a turn-key interactive forum for thoughtful discourse, earnest proposals and spirited speculation, and empowers subscribers to express, share, and network in regard to their opinions on social issues in order to facilitate more informed opinion formation and adaption.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed:

1. A system for expressing, sharing, and networking in regard to opinions on social issues in order to facilitate more informed opinion formation and adoption, comprising
a host computer in communication with a plurality of remote client computers via at least one communications network, said host computer including a processor and non-transitory storage media;
a database resident on the non-transitory storage media, said database comprising a plurality of subscriber profile records each containing profile data relating to a particular subscriber;
a subscriber interface for displaying a plurality of topics of social interest, a plurality of points of contention relevant to each of said plurality of topics, voting controls for allowing said subscribers to vote on said plurality of points of contention relating to a selected topic of social interest, and grouping controls for allowing each said subscriber to define a baseline comparison group;
a software module resident in the non-transitory storage media of said host computer for execution by said processor thereof, said module comprising computer instructions stored on non-transitory computer media for performing the steps of,
inputting a plurality of votes from each of said subscribers on said points of contention via said voting controls,
comparing said plurality of votes from one of said subscribers to said plurality of votes from a baseline comparison group of said subscribers predefined by said one subscriber via said grouping controls,
displaying statistical results from said comparison step to said one subscriber, and
prompting said one subscriber to change their votes on said plurality of points of contention relating to a selected topic of social interest after viewing said displayed statistical results.

2. The system according to claim 1, wherein said step of comparing said plurality of votes from one of said subscribers to said plurality of votes further comprises comparing said plurality of votes to a baseline comparison group of said subscribers predefined by said one subscriber using said grouping controls.

3. The system according to claim 1, wherein said voting controls require said subscribers to vote on said plurality of points of contention relevant to each of said plurality of topics individually.

4. The system according to claim 3, wherein said voting controls require said subscribers to vote on said plurality of points of contention relevant to each of said plurality of topics sequentially.

5. The system according to claim 2, wherein said software module further comprises computer instructions stored on non-transitory computer media for performing the step of allowing said one subscriber to define said baseline comparison group.

6. The system according to claim 5, wherein said step of allowing said one subscriber to define said baseline comparison group comprises a substep of filtering said plurality of votes from all of said subscribers based on said subscriber profiles.

7. The system according to claim 5, wherein said step of allowing said one subscriber to define said baseline comparison group comprises a substep of filtering by demographic, member group, or both.

8. The system according to claim 7, wherein said demographic includes subscriber Age, Gender, U.S. Region, Continent, Politics, and Religion.

9. The system according to claim 5, wherein said step of allowing said one subscriber to define said baseline comparison group comprises allowing said one subscriber to define two baseline comparison groups.

10. The system according to claim 1, wherein said subscriber interface for displaying said plurality of topics of social interest further comprises a control for allowing said plurality of subscribers to share said topics via email.

11. The system according to claim 1, wherein said subscriber interface for displaying said plurality of topics of social interest further comprises a control for allowing said plurality of subscribers to share said topics via social networking websites.

12. The system according to claim 5, wherein said step of displaying statistical results from said comparison step to said one subscriber further comprises displaying a voting wall displaying drop-down filters for custom-defined peer groupings to be sent to the comparison engine.

13. The system according to claim 5, wherein said step of allowing said one subscriber to define said baseline comparison group comprises allowing said one subscriber to select other subscribers for inclusion in said baseline comparison group.

14. A method for expressing, sharing, and networking in regard to opinions on social issues in order to facilitate more informed opinion formation and adoption, comprising software computer instructions stored on non-transitory computer media of a host computer for execution by a processor for performing the steps of:
displaying a plurality of topics of social interest, a plurality of points of contention relevant to each of said plurality of topics, and voting controls for allowing a plurality of subscribers to vote on said plurality of points of contention relating to a selected topic of social interest, and grouping controls for allowing each said subscriber to define a baseline comparison group;
inputting a plurality of votes from said plurality of users each of said subscribers on said points of contention via said voting controls,
comparing said plurality of votes from one of said subscribers to said plurality of votes from a baseline comparison group of said subscribers predefined by said one subscriber via said grouping controls,
displaying statistical results from said comparison step to said one subscriber, and
prompting said one subscriber to change their votes on said plurality of points of contention relating to a selected topic of social interest after viewing said displayed statistical results.

15. The method according to claim 14, wherein said step of comparing said plurality of votes from one of said subscribers to said plurality of votes further comprises comparing said plurality of votes to a baseline comparison group of said subscribers predefined by said one subscriber using said grouping controls.

16. The method according to claim 14, wherein said voting controls require said subscribers to vote on said plurality of points of contention relevant to each of said plurality of topics individually.

17. The method according to claim 16, wherein said voting controls require said subscribers to vote on said plurality of points of contention relevant to each of said plurality of topics sequentially.

18. The method according to claim 15, further comprising a step of allowing said one subscriber to define said baseline comparison group.

19. The method according to claim 18, wherein said step of allowing said one subscriber to define said baseline comparison group comprises a substep of filtering said plurality of votes from all of said subscribers based on said subscriber profiles.

20. The method according to claim 18, wherein said step of allowing said one subscriber to define said baseline comparison group comprises a substep of filtering by demographic, member group, or both.

21. The method according to claim 20, wherein said demographic includes subscriber Age, Gender, U.S. Region, Continent, Politics, and Religion.

22. The method according to claim 18, wherein said step of allowing said one subscriber to define said baseline comparison group comprises allowing said one subscriber to define two baseline comparison groups.

23. The method according to claim 18, wherein said subscriber interface for displaying said plurality of topics of social interest further comprises a control for allowing said plurality of subscribers to share said topics via email.

24. The method according to claim 16, wherein said subscriber interface for displaying said plurality of topics of social interest further comprises a control for allowing said plurality of subscribers to share said topics via social networking websites.

25. The method according to claim 18, wherein said step of displaying statistical results from said comparison step to said one subscriber further comprises displaying a voting wall displaying drop-down filters for custom-defined peer groupings to be sent to the comparison engine.

26. The method according to claim 18, wherein said step of allowing said one subscriber to define said baseline comparison group comprises allowing said one subscriber to select other subscribers for inclusion in said baseline comparison group.
